(19) United States
(12) Patent Application Publication
(10) Pub. No.: US 2007/0185855 A1
(43) Pub. Date: Aug. 9, 2007

(54) Method of Analyzing Link Popularity and Increasing Click-Through Ratios

(76) Inventors: Hiten Shah, La Mirada, CA (US); Neil Patel, La Palma, CA (US)

Correspondence Address: GREENBERG & LIEBERMAN, LLC, 2141 WISCONSIN AVE, N.W., SUITE C-2, WASHINGTON, DC, 20007, US

(21) Appl. No.: 11/307,175

(22) Filed: Jan. 26, 2006

(51) Int. Cl. G06F 17/30

(52) U.S. Cl. 707/5

(57) ABSTRACT

A method for tracking information about a visitor to a website, such as how the user arrived at the website, geographical location of the user, operating system, screen size, etc. The information is used to present optimized pages for the user based on similar user preferences. The preferences are gathered from repeated behaviors of similar users. The goal is to present links in the most favorable and relevant format possible so that users click on the links.

### FIELD OF THE INVENTION

The present invention concerns Internet traffic traveling within pages on websites on the Internet and links on websites that generate money for a website owner each time the links are clicked by a user. More particularly, the present invention is a method for presenting the links in the format and relevance that is best suited for encouraging the user to click on the links.

### BACKGROUND OF THE INVENTION

Ever since the mid-1990s, the Internet has been exploding exponentially in terms of use. Today, more than ever, more consumers and businesses have access to the Internet and as more consumers and businesses access the Internet, there is an ever-growing need to find desired information. Some users of the Internet know exactly where to find the information that they need and will type in the URL that corresponds to the page on the Internet that they would like to visit to find the information. Other users do not know where to find the information that they desire and, thus, those users will often go to a popular search engine, such as Google or Yahoo. Once on Google or Yahoo, the typical user will type in words that are associated with the information desired.

For example, if somebody is interested in finding information about getting a patent, that person might type in the phrase “getting a patent” into Google or Yahoo, and then Google or Yahoo would actually bring back results showing different web pages that offer related information. Often times, the user will click on the links or web pages that appear toward the top, or first, on the page of results, and for those looking to make money on the Internet, being at the top of the results page is paramount. Often times, those looking to make money on the Internet will take steps to place themselves high on the results page of Google or Yahoo.

When a user sees a link toward the top of Google or Yahoo, and the user clicks on that link, they often go to the page of somebody looking to generate money on the Internet. Generate money. It is commonplace for somebody to practice what is called monetization. Somebody who has a monetization page will offer information on his or her page relating to somebody's search. For example, if somebody is looking for information on how to obtain a patent, and they type in the phrase, “getting a patent” into Google, that person would then get a list generated by Google of different web locations on the Internet where more information about getting a patent can be obtained. If someone who has a monetization page is listed toward the top of the results provided by Google, then the user will most often click and go to that person's monetization page.

On the monetization page, information might be offered about patent attorneys, patent agents, patent search services, different types of patents, and other related information that is relevant to the search that the user performed. The person who owns the monetization page often times will provide a search feed from Google or Yahoo or another search engine as the results under the patent agent or the patent search or the patent attorney topic that is listed on the monetization page. And when the user clicks on one of those feed results, the owner of the monetization page makes money. Often times, a monetization page can simply be found because the user types in the URL, or web address, of the monetization page.

For example, a website located at www.Invention.com provides several different links relating to inventions, such as patent attorneys, patent agents, patent searches, patent forms, et cetera. When the user clicks on the patent agent heading or the patent attorney heading or the patent search heading, the user is then provided results that are literally a search feed from Google or a search feed from Yahoo, meaning that Google or Yahoo provide the search results that are displayed on the monetization page. When the user clicks on one of the search results that is fed from Google or Yahoo, the monetization page owner makes money, so that whether the user comes to the monetization page by actually typing in the URL, or web address, of the monetization page, or whether the user comes to the monetization page because the user has followed one of the first links on a search engine, the goal of the monetization page owner is always the same: to get the user to click on one of the feed links, so that the monetization owner makes money.

Another way to generate money from the Internet is to sell goods or services on a website. For example, dell.com offers a variety of computer and computer accessories. If someone goes to the dell.com homepage, the website owner wants the user to click on many of the deeper links, which eventually lead the user to the page to purchase a product. For example, a user searches on a search engine for “laptops” and clicks on dell.com, which is displayed in that search result. The user is then taken to the web page that was found to be the most sought out page from that specific search engine, and that specific web page may be the home page or any other web page on dell.com. The invention can identify a user trend, i.e.—that these people are leaving the site or are going to a specific laptop page on dell.com, and records it. Then, all of the future users who come from that specific search engine looking for that specific page will automatically be redirected to the most related page, leading them to purchase or accomplish the overall goal that the site owner intended. This instantaneous process is very quick so the users are not aware that they are being redirected. However, if a user's connection was slow, they might see a delay before being redirected by the system.

A website owner could have non-monetary goals in mind for their website. Even if a website is created to display information or provide free services, like an online chat, the website owner still establishes goals as to the destination of the users. The website's objective is to display the most relevant information. For example, if a sports team has a website, the most relevant information is for the schedule of matches. If more users click on the link to the schedule of matches when the homepage contains photos than when the homepage contains only text, then it is in the best interest of the webpage owner to leave the photos on the homepage.

In the website or monetization page owner's quest to get users to click on as many links and pages as possible, website owners are always trying new graphical formats, new layout formats, different choices of information, different feeds from different information services, such as a feed from Google, versus a feed from Yahoo. Ultimately, the goal is to get user traffic to the web page and then encourage the user traffic to either click on as many feed links as possible so that the monetization page owner gets money, or to click on as pages deeper in the website so that the web page owner gets new customers.

As anyone can imagine, keeping track of where users click and which pages or graphical representations or layouts encourage users to click more often than not is an arduous task. Currently, a web page or monetization page owner might try out one graphical or layout page for one week, and then try out another graphical or layout page for another week, and the web page or monetization page owner would have to look at stacks that are computed to actually determine which layout or formats encourage more clicks and click-throughs. Doing so is rather labor-intensive, and often times, a web page owner or monetization page owner desires the web page or monetization page to generate money on its own, with little upkeep necessary.

Thus, there is a need for a method for analyzing click-through traffic on monetization pages and user traffic on web pages based upon the layout and/or presentation of the web page or monetization page. And further, there is a need for analyzing which search terms that a user might employ correlate with which clicks and click-throughs to generate the most traffic.

### SUMMARY OF THE INVENTION

A method for use with web pages and monetization pages is presented. The present invention increases click-through ratios on monetization pages and deeper page viewing ratios on web pages by optimizing the presentation of the monetization page or web page to the user. The optimization is done by tracking the users. For example, if a cooking page on about.com, which is a monetization website, is linked to BettyCrocker.com and users enter the company site through the about.com link, the present invention would monitor those users. If it notices that those users are met with a page related to recipes, but those users prefer to look at the products pricing page, then all new visitors coming from that link on about.com will be directed directly to the products pricing page.

If users are coming directly to a website without the use of a monetization site, the present invention is still capable of tracking and analyzing users backgrounds. It will track visitor data, such as IP address, geographic location, screen resolution of the visitor, operating system of the computer, internet connection speed, time of day, resolution of the window size, visitor has flash, javascript is enabled and other data that may be collected. Based on that information, the system may present different pages to different users. If a user from California visited Comcast.com they would be directed to Comcast's west coast webpage, as opposed to a user from Virginia, who would be directed to Comcast's east coast page.

Thus, link popularity is increased by the present invention because the monetization page owner or web page owner will be able to automatically, via the present invention, know which clicks and click-through links are those that are desired by users, depending on the keywords that bring a user to the monetization page or web page. This would help give the user what they were looking for and also help the website owner increase sales and conversion rate. If the owner of BettyCrocker.com wanted users to go to the company contact page instead to help increase sales or leads, the website owner can overwrite the system and have it redirect all new visitors that come from the about.com link to the company contact page instead.

### BRIEF DESCRIPTION OF THE DRAWINGS

FIG. 1 shows a flow chart of the present invention.

### DETAILED DESCRIPTION OF THE PREFERRED EMBODIMENT

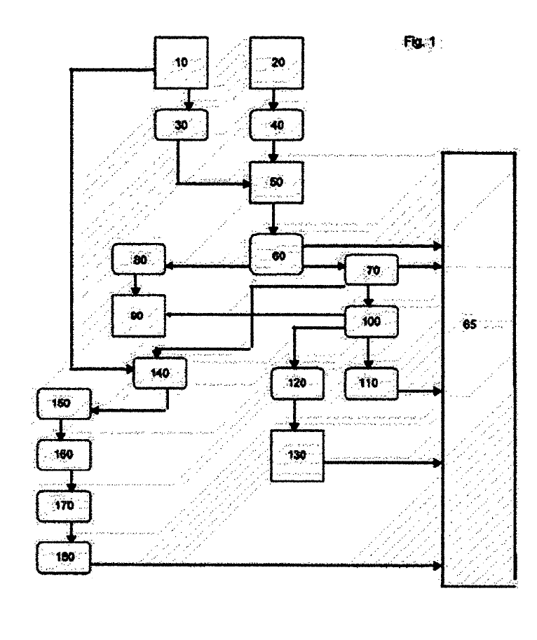

As shown in FIG. 1, the website home page (50) can be reached either from another website (10) or a search engine (20). The user reaches website home page (50) from another website (10) and then the user clicks on a referring link (30) that takes the user to website home page (50). If the user reaches website home page (50) from search engine (20), then presumably the user has typed in a keyword or keywords into search engine (20) and the search result (40) directs the user to website home page (50).

Once the user has reached website home page (50), the present invention checks for a keyword used to generate search result (40) or checks for another website (10) that had referring link (30). A check (60) is important because the present invention needs to ascertain how the user arrived at website home page (50). If after the check (60), it is determined that the referring link (30) from another website (10), or the keyword that was entered into search engine (20) to produce search result (40) is not listed in a database of the present invention, then according to the present invention, the referring link (30) on another database (10) is then written to the database in writing step (70).

Similarly, if the keyword that was typed into search engine (20) to produce search result (40) is not listed in the database of the present invention, then writing step (70) involves writing the keyword that was entered into search engine (20) to produce search result (40) into the database.

It should be understood that once the referring link (30) from another website (10) has gone through the writing step (70), so that it is in the database of the present invention, the writing step (70) will no longer occur. Similarly, once the keyword that was entered into search engine (20) to produce search result (40) goes through the writing step (70) into the database of the present invention, writing step (70) will no longer occur for that keyword coming from search engine (20). Instead, rather than moving from check (60) to writing step (70), the present invention will move from check (60) to directing step (80). Directing step (80) will direct the user to cataloged content according to either the keyword that the user typed in search engine (20) to get search result (40), or will direct the user to cataloged content according to the referring link (30) from another website (10) that the user clicked to get to website home page (50). Content pages (90) are the specific content pages that directing step (80) directs the user to based upon the keyword that was typed in search engine (20) to get the search result (40), or the referring link (30), from another website (10) that the user used to get to website home page (50).

Turning to writing step (70), after the keyword or referring site information is written to database (65), more specific information is gathered regarding the keyword or referring site, and written to database (65). For example, the present invention tracks user content usage (100), logged as conversion events (110), determines customer statistics (120) and grabs generic information about the user (130), such as browser type, screen size, geographical location, screen resolution, IP address, Internet service provider and operating system. In short, it tracks user contact usage (100) while conversion events (110) determines customer statistics (120) and generic information (130) is all recorded in database (65).

Once that information is recorded in database (65), then the keyword that the user used in search engine (20) to get search result (40) or the referring link (30) from another website (10) is considered listed in the present invention, such that the writing step (70) will no longer occur in one embodiment of the present invention. And after check (60), the present invention will move to directing step (80), rather than going to writing step (70). The present invention also rates referring site statistics (140), weights keyword density (150), views Meta tags (160), analyzes anchor text (170) and catalogs content pages (180).

With the goal of the present invention to increase link popularity and increase click-through ratios and deeper page viewing ratios to generate more money for the owner of a website, it is contemplated that rather than just one writing step (70) occurring after check (60), that an alternative embodiment of the present invention could have writing step (70) occurring for a preset time. For example, writing step (70) might occur for an entire month before it is determined that a keyword or referring site is listed in database (65), so that check (60) would then move to directing step (80). In short, logic dictates that the longer check (60) moves to writing step (70), the more samples will be collected in database (65), and thus, content pages (90) that the user is directed to will be that much more in line with the content that the user is actually looking for.

In short, the goal of the present invention is to track the movement of users from the time the user clicks on referring link (30) for search result (40) to reach website home page (50). All users will reach website home page (50), but the presentation of information, or as shown in FIG. 1, the content pages (90), will vary because the present invention will check database (65) at check (60) and ultimately, present content pages (90) that are most often frequented by other users that have clicked on the same or similar referring links (30) for the same or similar search result (40).

The present invention assumes that if there is a more popular path that users are taking, for example, if tracks user content usage (100) shows that users tend to gravitate toward a few links, then the present invention will present those few links first on content pages (90), so that subsequent users who come to website home page (50) via a similar path as other users, will see the most popular content pages (90) that other users have shown an interest in. By showing an interest, the present invention assumes that an interest is represented by the user clicking on a link, and that link that the user clicks on to show an interest, is a link that is a pay-per-click link, so that the owner of website home page (50) will get paid and receive money.

Thus, in short, the present invention tracks users that reach website home page (50), records the user's actions and analyzes other data associated with the user, and then presents information with links in the most profitable way possible, so that if there are certain links that users tend to click on, who have searched with a particular keyword on Google, then the present invention will present those links first to the next users who come to website home page (50) via the same keywords typed into Google. Even more particularly, the links presented will be even more specifically associated with the geographic area that the person is located in, compared to other users who have come via that same keyword from that same search engine.

Alternatively, rather than presenting the most popular links for a certain profile of user that has come to website home page (50), the present invention could present the links that are most popular in the particular layout that has historically, according to database (65), generated the most clicks and click-throughs. For example, if links that, when clicked, will generate money for the owner of website home page (50), are presented on a yellow background, and also on a red background, and also on a green background, then the present invention could be used to track how users come to website home page (50), and what type of users, coming in certain, particular ways to website home page (50) will tend to click on more links when those links are presented on the yellow background or any other color background.

Once the present invention has done this, then subsequent users, who have similar characteristics in coming to website home page (50), will then automatically be shown the yellow background with links if that yellow background has proven to generate many deeper clicks and click-throughs for similar users with similar characteristics.

Alternatively, the present invention could operate from any of the internal pages within a website. This process is not restricted to the homepage (50).

The present invention is not limited to the embodiments aforementioned, but is all and any embodiments within the scope of the following claims.

What is claimed is:

1. A method for providing relevant information about a user's visit to a webpage, comprising:
recording information about pages viewed within the webpage by at least one user;
determining the pages most often viewed by the at least one user;
directing users after said at least one user to the pages most often viewed by the at least one user;
determining how the user arrived at the webpage.

2. The method of claim 1 wherein recording said information is writing information to a database.

3. The method of claim 1 wherein recording said information occurs for a pre-determined period of time.

4. A method in claim 2 wherein there is a way of tracking the keywords typed into the search engine by the users.

5. A method as in claim 3 wherein there is a method of obtaining additional information about the person accessing the webpage, which is chosen from the group of:
geographical location;
browser type;
IP address;
screen resolution;
operating system;
keywords entered into a search engine;
Internet service provider; or
screen size.

6. A method as in claim 5 where said additional information is subsequently written into said database.

7. A method as in claim 6 that shows which web pages a third party has accessed.

8. A method as in claim 7 where one can determine the number of clicks the user needs to arrive at said webpage.

9. The method of claim 1 wherein determining the pages most often viewed by the at least one user is used for monetization purposes.
